(19) United States
(12) Patent Application Publication
(10) Pub. No.: US 2008/0225445 A1
(43) Pub. Date: Sep. 18, 2008

(54) Arc-discharge protection device with temperature detection mode

(75) Inventors: Ying-Chang Cheng, Taipei Hsien (TW); Chin-Biau Chung, Taipei Hsien (TW)

Correspondence Address: Joe McKinney Muncy, PO Box 1364, Fairfax, VA, 22038-1364, US

(73) Assignee: ZIPPY TECHNOLOGY CORP.

(21) Appl. No.: 11/717,768

(22) Filed: Mar. 14, 2007

(51) Int. Cl. H02H 3/02

(52) U.S. Cl. 361/2

(57) ABSTRACT

The present invention discloses an arc-discharge protection device with a temperature detection mode, which is used to detect the arc discharge persistently occurring in between an inverter and a load during an abnormal power transmission state and is arranged in a connector coupling said inverter and said load and implementing the high-voltage power transmission therebetween. In the present invention, a temperature signal sampling unit is used to detect a temperature change of the connector and generate a temperature-change signal; next, an interpretation unit receives the temperature-change signal and utilizes a decision level to determine whether the temperature change is the abnormal high temperature phenomenon caused by arc discharge and outputs an abnormal-temperature signal if the interpretation result is positive; and a trigger unit is driven by the abnormal-temperature signal to interrupt the inverter's outputting high-voltage power to the load.

### FIELD OF THE INVENTION

The present invention relates to a power protection device, particularly to an arc-discharge protection device, which applies to the connector for a high voltage output. When arc discharge occurs with an instantaneous high temperature phenomenon during an abnormal state, the present invention can detect the high temperature phenomenon and generate a triggering signal to interrupt the power source of the high voltage output.

### BACKGROUND OF THE INVENTION

When a high voltage is applied to two electrodes, and when the two electrodes are moved to each other gradually, and when a given spacing between the two electrodes is reached, the so-called arc discharge will occur. Arc discharge is similar to the lightning generated by thunderclouds. In contrast to the momentariness of lightning, the electric sparks between two electrodes can persist for a long time and result in heat accumulation.

In electronic circuits, arc discharge usually causes the malfunction or damage of electronic elements, or even a fire, which may endanger life. In the traditional high-voltage loads, such as CCFL (Cold Cathode Fluorescent Lamp), EEFL (External Electrode Fluorescent Lamp), anion generators, cathode ray tubes, etc., arc discharge will occur because of the point discharge resulting from an imperfect contact, a humidity/temperature change or a broken/damaged circuit element between the load and the high-voltage power source. U.S. Pat. No. 6,940,234 and U.S. Pat. No. 6,867,955 disclosed a voltage detection mode to prevent from arc discharge, wherein a voltage-conversion unit of an arc-discharge protection device receives a high-voltage arc-discharge signal from a high-voltage output section and converts the high-voltage arc-discharge signal into a low-voltage arc-discharge signal; a rectifier unit rectifies the low-voltage arc-discharge signal and outputs an arc-discharge noise; a trigger unit detects the arc-discharge noise and outputs a triggering signal to interrupt a control unit or a driving unit lest arc discharge result in heat accumulation on the peripheral elements, which causes a burnout or a fire. Besides, R.O.C. Publication patent No. 591976 and No. 591839 disclosed arc-discharge protection devices with a current detection mode.

However, the abovementioned voltage detection mode and current detection mode need a complicated circuit, including the voltage conversion unit, the filter unit, the rectifier unit, etc., which increases the fabrication time and fabrication cost and lays a great burden on manufacturers and consumers.

### SUMMARY OF THE INVENTION

The primary objective of the present invention is to prevent the arc discharge with an instantaneous high temperature phenomenon, which occurs in the connector of a high voltage output during an abnormal state and to provide an arc-discharge protection device, which can detect the high temperature phenomenon and trigger the shutoff of the power source of the high voltage output.

Another objective of the present invention is to utilize a low-cost temperature signal sampling unit to detect arc discharge and trigger a control signal to prevent from the damage caused by arc discharge.

To achieve the abovementioned objectives, the present invention proposes an arc-discharge protection device with a temperature detection mode, which can detect the arc discharge persistently occurring in between an inverter and a load during an abnormal power transmission state. The arc-discharge protection device is arranged in a connector coupling an inverter and a load and implementing the high-voltage power transmission therebetween. The arc-discharge protection device of the present invention comprises the following components: a temperature signal sampling unit used to detect the temperature change of the connector and generate a temperature-change signal; an interpretation unit receiving the temperature-change signal and utilizing a decision level to determine whether the temperature change is the abnormal high temperature phenomenon caused by arc discharge and outputting an abnormal-temperature signal; and a trigger unit driven by the abnormal-temperature signal to output a triggering signal to interrupt the inverter's outputting high-voltage power to the load.

### BRIEF DESCRIPTION OF THE DRAWINGS

FIG. 1 is a block diagram schematically showing the architecture of the arc-discharge protection device with a temperature detection mode according to a preferred embodiment of the present invention.

FIG. 2 is a diagram schematically showing the appearance of the arc-discharge protection device with a temperature detection mode according to a preferred embodiment of the present invention.

FIG. 3 is a diagram schematically showing the appearance of the arc-discharge protection device with a temperature detection mode according to another preferred embodiment of the present invention.

FIG. 4 is a diagram schematically showing the appearance of the arc-discharge protection device with a temperature detection mode according to yet another preferred embodiment of the present invention.

### DETAILED DESCRIPTION OF THE PREFERRED EMBODIMENTS

The technical contents of the present invention are to be described in detail in cooperation with the drawings below.

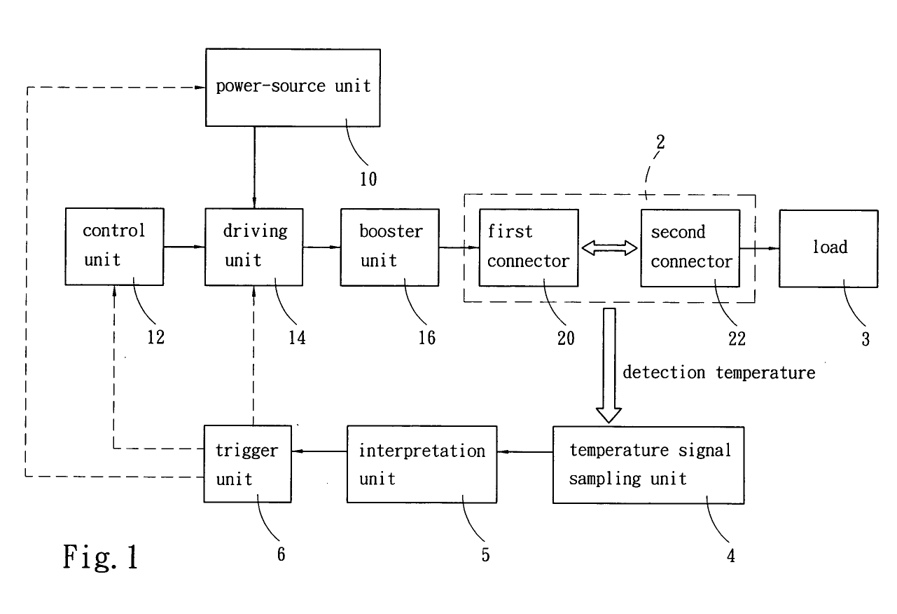

Refer to FIG. 1 a block diagram schematically showing the architecture according to a preferred embodiment of the present invention. The present invention pertains to an arc-discharge protection device with a temperature detection mode, which is used to detect the arc discharge persistently occurring in between an inverter 1 and a load 3 during an abnormal power transmission state; for example, there is an imperfect contact, a humidity/temperature change, or a broken/damaged circuit element. The arc-discharge protection device is arranged in a connector 2 coupling the inverter 1 and the load 3 and implementing the high-voltage power transmission therebetween. In this embodiment, the inverter 1 includes a power-source unit 10 inputting power, a control unit 12 providing a voltage-distribution signal, a driving unit 14 receiving the power and the voltage-distribution signal and transforming voltage, and a booster unit 16 receiving the transformed voltage and boosting the transformed voltage into a high voltage. The power inputting, voltage distribution, voltage transformation, and voltage boosting of an inverter are not the characteristics of the present invention but the conventional technologies; therefore, those will not repeat herein. The connector 2 further comprises a first connector 20 arranged in the inverter 1 and a second inverter 22 coupling to the first connector 20 and transmitting high-voltage power to load 3 at the rear end, wherein the load 3 is an electronic device driven by a high voltage, such as a gas discharge lamp (CCFL, HCFL (Hot Cathode Fluorescent Lamp), or EEFL) or an anion generator. The arc-discharge protection device comprises the following components: a temperature signal sampling unit 4, an interpretation unit 5 and a trigger unit 6.

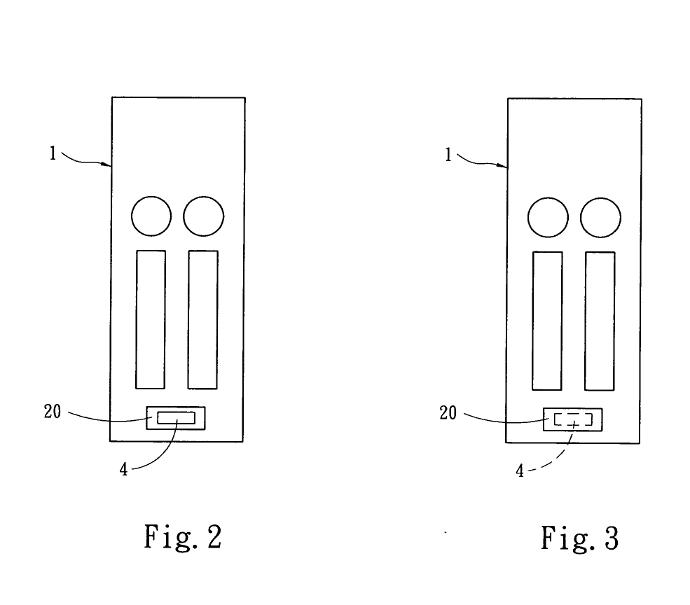

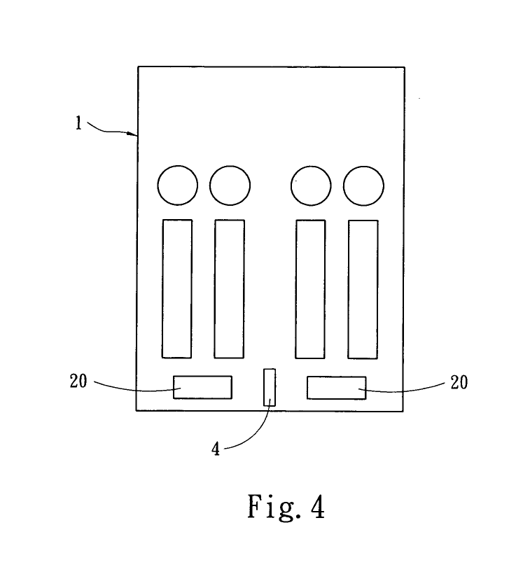

The temperature signal sampling unit 4 is used to detect a temperature change of the connector 2 and generate a temperature-change signal. The temperature signal sampling unit 4 may be a PTC (Positive Temperature Coefficient) sensor, a silicon IC temperature sensor, a RTD (Resistance Temperature Detector), a thermistor, or a thermocouple. The temperature signal sampling unit 4 may also be a combination of the abovementioned sensors. FIG. 2 shows that the temperature signal sampling unit 4 is arranged in the external surface of the first connector 20. FIG. 3 shows that the temperature signal sampling unit 4 is arranged in the internal surface of the first connector 20. FIG. 4 shows that the temperature signal sampling unit 4 is arranged in either side of the first connector 20, and that the inverter 1 has two first connectors 20. Therefore, two first connectors 20 can jointly use a single temperature signal sampling unit 4, and the cost is thus reduced.

The interpretation unit 5 receives the temperature-change signal and utilizes a decision level to determine whether the temperature change is the abnormal high temperature phenomenon caused by arc discharge. If the interpretation result is positive, the interpretation unit 5 outputs an abnormal-temperature signal.

The trigger unit 6 is driven by the abnormal-temperature signal to output a triggering signal to interrupt the inverter 1's outputting high-voltage power to the load 3 to prevent from arc discharge. In this embodiment, the trigger unit 6 may trigger the power-source unit 10, the control unit 12, the driving unit 14 or the booster unit 16 to interrupt the output of the high-voltage power of the inverter 1. The trigger unit 6 is a switching device, such as a silicon-controlled rectifier, a flip-flop or a transistor. The switching device is driven by the abnormal-temperature signal to shut off the power source.

Further, the arc-discharge protection device with a temperature detection mode of the present invention can cooperates with the voltage detection mode disclosed in the U.S. Pat. No. 6,940,234 and no. 6867955 or the current detection mode disclosed in the R.O.C. patent No. 591976 and No. 591839 to attain a dual-mode protection. Once one mode thereof fails, the other mode can still protect the circuit. Thereby, the arc-discharge protection is enhanced.

Summarily, in the present invention, a temperature signal sampling unit 4 is used to detect the arc discharge with an instantaneous high temperature phenomenon, which occurs in a connector 2 during an abnormal state; an interpretation unit 5 is used to filter out an abnormal-temperature signal; then, a trigger unit 6 is driven by the abnormal-temperature signal to shut off the inverter 1 and interrupt the high-voltage power. The present invention can utilize the simple and low-cost circuit of the temperature signal sampling unit 4 to achieve the same arc-discharge protection effect as the conventional technologies. Then, the fabrication time is shortened, the fabrication cost reduced, the burden of manufacturers and consumers decreased, and the competence promoted. Therefore, the present invention indeed possesses novelty and non-obviousness and meets the requirements of a patent. Thus, the Inventors file the application for a patent. It will be greatly appreciated if the patent is approved fast.

The preferred embodiment has been described in detail above to exemplify the present invention. However, it is not intended to limit the scope of the present invention. Any equivalent modification or variation according to the spirit of the present invention is to be also included within the scope of the present invention.

What is claimed is:

1. An arc-discharge protection device with a temperature detection mode, which is used to detect the arc discharge persistently occurring in between an inverter and a load during an abnormal power transmission state and is arranged in a connector coupling said inverter and said load and implementing the high-voltage power transmission therebetween, comprising the following components:
a temperature signal sampling unit detecting a temperature change of said connector and generating a temperature-change signal;
an interpretation unit receiving said temperature-change signal and utilizing a decision level to determine whether said temperature change is the abnormal high temperature phenomenon caused by arc discharge and outputting an abnormal-temperature signal if the interpretation result is positive; and
a trigger unit driven by said abnormal-temperature signal to interrupt said inverter's outputting high-voltage power to said load.

2. The arc-discharge protection device with the temperature detection mode according to claim 1, wherein said inverter includes a power-source unit inputting power, a control unit providing a voltage-distribution signal, a driving unit receiving said power and said voltage-distribution signal and transforming voltage, and a booster unit receiving the transformed voltage and boosting said transformed voltage into a high voltage.

3. The arc-discharge protection device with thetemperature detection mode according to claim 2, wherein said trigger unit triggers said control unit to interrupt the output of said high-voltage power.

4. The arc-discharge protection device with the temperature detection mode according to claim 2, wherein said trigger unit triggers said driving unit to interrupt the output of said high-voltage power.

5. The arc-discharge protection device with the temperature detection mode according to claim 2, wherein said trigger unit triggers said power-source unit to interrupt the output of said high-voltage power.

6. The arc-discharge protection device with the temperature detection mode according to claim 1, wherein trigger unit is a silicon-controlled rectifier.

7. The arc-discharge protection device with the temperature detection mode according to claim 1, wherein said temperature signal sampling unit is a PTC (Positive Temperature Coefficient) sensor, a silicon IC temperature sensor, a RTD (Resistance Temperature Detector), a thermistor or a thermocouple, and said temperature signal sampling unit may also be a combination of the abovementioned sensors.

8. The arc-discharge protection device with a temperature detection mode according to claim 1, wherein said temperature signal sampling unit is arranged in the external surface of said connector.

9. The arc-discharge protection device with a temperature detection mode according to claim 1, wherein said temperature signal sampling unit is arranged in the internal surface of said connector.

10. The arc-discharge protection device with a temperature detection mode according to claim 1, wherein said temperature signal sampling unit is arranged beside said connector.
